(19) United States
(12) Patent Application Publication
(10) Pub. No.: US 2007/0153796 A1
(43) Pub. Date: Jul. 5, 2007

(54) Packet processing utilizing cached metadata to support forwarding and non-forwarding operations on parallel paths

(75) Inventors: Vijay Sarathi Kesavan, Hillsboro, OR (US); Shuchi Chawla, Tigard, OR (US)

Correspondence Address: Ryder IP Law;C/O PortfolioIP, P.O. Box 52050, Minneapolis, MN, 55402, US

(73) Assignee: Intel Corporation

(21) Appl. No.: 11/322,831

(22) Filed: Dec. 30, 2005

(51) Int. Cl. H04L 12/56

(52) U.S. Cl. 370/392; 370/401

(57) ABSTRACT

In some embodiments a network processor is described that includes cache to store metadata for individual packets. The cached metadata is utilized separately for forwarding and non-forwarding based functional units so that the forwarding and non-forwarding operations can be segregated. The cached metadata may be maintained after an associated individual packet is egressed so that non-forwarding operations can be completed after the associated packet has been egressed and hence impact to forwarding rate minimized. The cached metadata may be utilized separately by parallel processing paths. The parallel processing paths may be forwarding based so that parallel operations can be performed on metadata associated with an individual packet and the packet processing latency can be reduced. Other embodiments are otherwise disclosed herein.

### BACKGROUND

Packet processing systems (network processors) may be used in network equipment to process data (e.g., packets). For example, network processors may be used in store-and-forward devices (e.g., routers, switches, firewalls). Store-and-forward devices receive packets, process the packets and transmit the packets. The packets may be received from one or more sources and may be forwarded to one or more destinations. The store-and-forward device may include one or more interface cards to receive and transmit the packets. The store-and-forward devices may also include a switching fabric to selectively connect different interface cards so that the packets can be switched (forwarded from a receiving interface card to a transmitting interface card). The interface cards may include the network processors to perform the processing on the packets. The processing may be simple or complex. The processing may include routing, manipulation (e.g., editing), computation, classification, and statistics.

The packets received may include the actual data (payload) and information about the data (header). The header may include details regarding source, destination, and priority of the packets. The network processor may receive the packets and derive metadata from the packets. Each packet may be associated with unique metadata even though the metadata is not transmitted with the packets. The metadata may include the header (or a portion thereof), part of the payload, and information that has been computed or derived from the header and payload. In addition, the metadata may include information regarding when the packets entered the device (e.g., time stamp), interface on which the packets entered the device, and length of the packets.

The network processor may process the metadata rather than the packets. The metadata for individual packets may be handled by multiple processing engines in series. Some of the processing may be required in order to forward the packets (e.g., editing, routing) while some of the processing may be independent of packet forwarding (e.g., statistics). After processing of the metadata is complete, the packets may be retrieved from memory, modified if required, and forwarded.

### BRIEF DESCRIPTION OF THE DRAWINGS

The features and advantages of the various embodiments will become apparent from the following detailed description in which:

FIG. 1 illustrates a high-level block diagram of an example network processor, according to one embodiment;

FIGS. 2A-D illustrate several example functional unit arrangements for processing metadata associated with multiple packets, according to one embodiment;

FIG. 3 illustrates an example network processor having forwarding based operations and non-forwarding based operations parallel paths for processing of metadata associated with individual packets, according to one embodiment;

FIGS. 4A-4C illustrate several example critical path and non-critical parallel branches for processing metadata associated with individual packets, according to one embodiment;

FIG. 5 illustrates an example network processor defining parallel paths for processing of metadata associated with individual packets, according to one embodiment;

FIGS. 6A-6C illustrate several example parallel branches of functional units for performing parallel operations on metadata for individual packets, according to one embodiment;

FIG. 7 illustrates an example network processor defining multiple parallel critical paths and multiple parallel non-critical branches for processing of metadata associated with individual packets, according to one embodiment;

FIG. 8 illustrates an example network processor having multiple parallel packet processing blocks, where each block is capable or performing forwarding and non-forwarding based parallel operations on metadata associated with individual packets, according to one embodiment; and

FIG. 9 illustrates an example network processor having multiple forwarding based parallel packet processing blocks for performing forwarding based parallel operations on metadata associated with individual packets and a non-forwarding based parallel packet processing block for performing non-forwarding based parallel operations on metadata associated with each individual packet being processed by a forwarding based parallel packet processing block, according to one embodiment.

### DETAILED DESCRIPTION

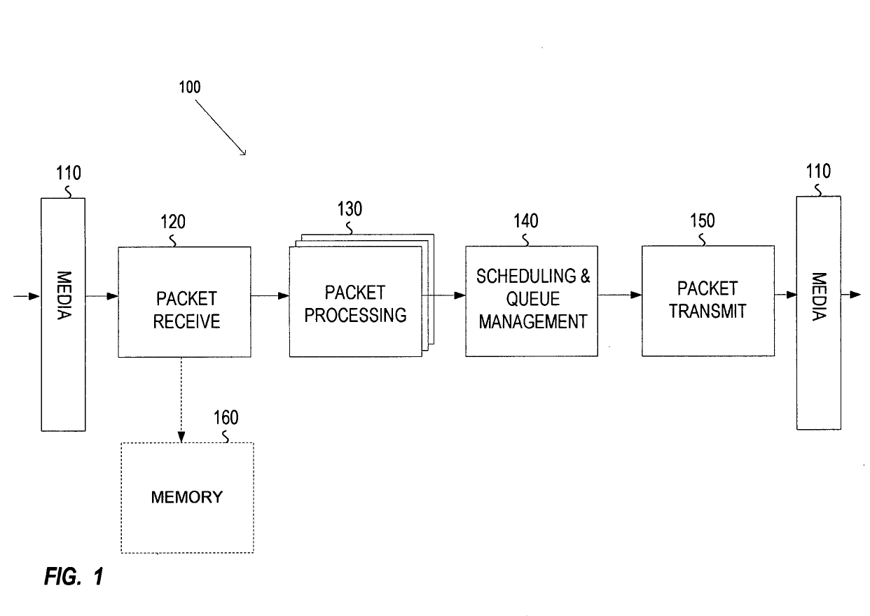

FIG. 1 illustrates a block diagram of an example packet processing system (network processor) 100. The network processor 100 may include media 110, a packet receive processing engine (receiver) 120, packet functional processing engines (functional units) 130, a scheduling and queue management processing engine (scheduler) 140, and a packet transmit processing engine (transmitter) 150. The media 110 may provide an interface for receiving data (packets). The packets received may be associated with different protocols (e.g., Ethernet, Utopia, and High Speed Serial (HSS)). The network processor 100 may include different media 110 to interface with the different protocols. The receiver 120 may receive the packets from the media 110. The network processor 100 may include different receivers 120 to receive the packets from the different protocols.

The packets may include a payload (data) and a header (information about the payload). The header may include details regarding source, destination, and priority of the packets. Metadata may be collected and/or derived from the packets (header, payload) and other factors (e.g. time stamp). The metadata may be proprietary and opaque to the external world and hence can be defined and structured to exploit the features of the system architecture. The metadata collected/derived may depend on the operations to be performed. The metadata may include some subset of source IP address, destination IP address, protocol, source port, destination port, packet size, and ingress timestamp.

The receiver 120 may extract/derive the metadata from the packets and may store the packets (and possibly metadata) in memory 160. The memory 160 may be one or more memory devices. The packets may be stored in a plurality of queues defined within the memory 160. The queues may be associated with various parameters including source, destination, priority, quality of service (QoS), and protocol. The receiver 120 may examine the header and/or metadata and based thereon store the packets in the appropriate queues. Due to the large size of the packets, the packets may not be passed between the functional units 130 (and the scheduler 140) or accessed by the functional units 130. Accordingly, the packets may likely be stored in slower memory, such as dynamic read access memory (DRAM).

The metadata may be used by the functional units 130 and the scheduler 140. The metadata may be forwarded from one functional unit 130 to the next (e.g., a buffer containing the metadata may be forwarded from one functional unit 130 to the next). Alternatively, the metadata may be stored in memory 160 and the functional units 130 may access the metadata from the memory 160. The functional units 130 may read and/or modify the metadata several times to evaluate packet forwarding decisions, perform packet editing, and other functions. Due to frequent access, the metadata may be stored in fast access memory, such as cache.

The memory 160 may be local to the network processor 100 (on the processor die), may be separate from the network processor 100 (off-die memory), or some combination thereof (e.g., cache on-die for metadata and DRAM off-die for packets).

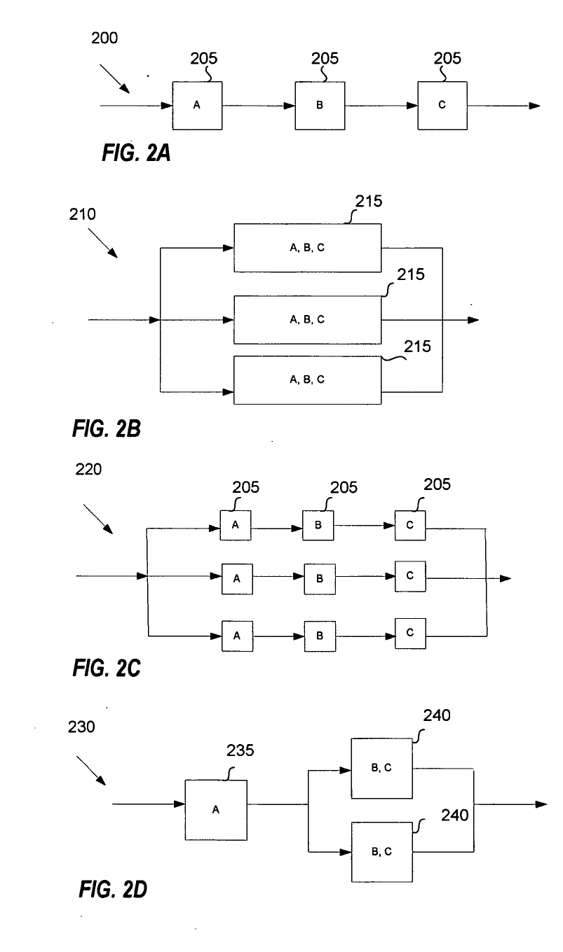

The functional units 130 may perform operations including forwarding, routing, editing, classification, and computation (statistics). The operations may be performed either on the metadata or using the metadata. The operations may be pipelined so that different processors 130 perform different functions on the metadata for the packets and are aligned linearly (see FIG. 2A). For pipelined operations, the metadata for individual packets are passed from one functional unit 130 to another with each functional unit 130 performing a subtask on the metadata. The operations may be parallel so that multiple functional units 130 perform the same operations on metadata associated with different packets and are aligned parallel to one another (see FIG. 2B). For parallel operations, the metadata for different packets is routed to different functional units 130 and each functional unit 130 performs the same functions on the metadata routed thereto (metadata associated with multiple packets can be processed together). The operations may be some combination of pipelining and parallelism (see FIGS. 2C and 2D).

FIGS. 2A-2D illustrate example arrangements of functional units (e.g., 130 of FIG. 1) performing functions/sub-tasks A, B and C (e.g., classifying, editing, forwarding). FIG. 2A illustrates an example pipelined functional unit arrangement 200. The pipelined arrangement 200 includes a plurality of functional units (e.g., three) 205 aligned in series, each functional unit 205 performing a unique function (e.g., subtask). The metadata for individual packets may be handled by each of the functional units 205 (A, B, C). FIG. 2B illustrates an example parallel functional unit arrangement 210. The parallel arrangement 210 includes three functional units 215 aligned in parallel, each functional unit 215 performing multiple functions (A,B, C). The metadata for different packets may be routed to different parallel paths so that the metadata for different packets may be handled by different functional units in parallel. Each parallel path performs functions (A, B, C) on the metadata associated with packets routed to that parallel path.

FIG. 2C illustrates an example parallel/pipelined functional unit arrangement 220. The parallel/pipelined arrangement 220 includes a plurality of parallel paths with each path having a plurality of functional units 205 aligned in series. The metadata for different packets may be handled by different parallel paths, and the metadata for individual packets routed to a particular parallel path may be handled by each functional unit 205 within the path. Each parallel path performs functions (A, B, C) on the metadata associated with packets routed to that parallel path. FIG. 2D illustrates an example pipelined/parallel functional unit arrangement 230. The pipelined/parallel arrangement 230 includes a unique functional unit 235 in series with parallel paths. The parallel paths include functional units 240 performing multiple functions (B,C). The metadata associated with each packet is processed by the functional unit 235 and then the metadata for different packets is routed to different parallel paths. The functions B and C may be performed on the metadata for different packets by different functional units in parallel. Each parallel path performs functions (B, C) on the metadata associated with packets routed to that parallel path.

Returning to FIG. 1, once all operations on the packets are complete, any changes to the metadata are reflected onto the packet. After the functional units 130 are finished with the metadata the scheduler 140 may use the metadata for scheduling transmission of the packets. The scheduling of the packets may be based on different parameters including the parameters associated with the queues (e.g., source, destination, priority, quality of service (QoS), protocol). The scheduling may also be based on the algorithm employed (e.g., round robin (RR), weighted RR (WRR), deficit RR (DRR)), the amount of data in the queues, and the amount of time the data has been in the queues. Once the packet is scheduled, the scheduler 140 may forward data regarding the scheduled packets to the transmitter 150. The transmitter 150 may retrieve the packets from memory 160 and transmit (egress) the packets out of the network processor 100 via the media 110. After the packets are egressed from the system the metadata may be discarded.

The goal of many systems utilizing network processors (e.g., switches, routers), is to minimize the time spent by the packets in the system so that the line rate (forwarding rate) is preserved. However, operations on the packets take finite time to complete and their cumulative effect may impact the forwarding rate of the packet.

The network processor 100 performs the functions on the metadata for individual packets in series (one at a time) whether the functional units 130 are pipelined, parallel, or some combination thereof. The operations performed by the functional units 130 (e.g., packet editing and packet forwarding decisions) on the metadata for an associated packet may be required to be performed prior to the associated packet egressing the system (“forwarding based operations”). However, some operations (e.g., operations that require no modifications, operations that do not have any impact on packet forwarding decisions) may not be required to be performed before the associated packet egresses the system (“non-forwarding based operations”). Delaying the egressing of the associated packet while awaiting completion of non-forwarding operations on the associated metadata may impact the forwarding rate of the packets.

For non-forwarding based operations it is not necessary, and may be detrimental, to hold onto the associated packets until the non-forwarding based operations are complete on the associated metadata. The packets may be egressed after the forwarding based operations are complete, regardless of the status of the non-forwarding based operations on the associated packets. The non-forwarding based operations may be performed on the metadata after the packets are egressed. The metadata may be maintained in memory (e.g., cache) until the non-forwarding operations are complete. After the non-forwarding-based operations are complete the associated metadata may be discarded.

Completing the non-forwarding based operations separate from the forwarding based operations (e.g., after the packets have been egressed) may reduce processing time for individual packets thereby increasing the forwarding rate, as egress of the packets will not be contingent on completion of the non-forwarding operations. Furthermore, since the non-forwarding operations are not critical to egress of the packets these operations may be performed using fewer resources so that additional resources may be dedicated to forwarding based operations and the forwarding rate may be reduced further.

The non-forwarding operations may be able to user slower memory and slower processors so that the faster memory and faster processors can be dedicated to forwarding based operations. The non-forwarding based operations may be performed when the load on the system is lower, during inter-packet gaps, or when traffic passing through the system is low. The time for which the non-forwarding operations may be delayed may depend on the number of packets awaiting non-forwarding based operations, the memory available for maintaining the metadata associated with egressed packets (the non-forwarding metadata), and timing requirements associated with when the non-forwarding based operations must be performed.

Statistics collection may be an operation that need not be performed prior to packets egressing the system (may require no modification of the metadata or have any impact on packet forwarding decisions). Statistics collection may involve classifying the packets into flows based on packet parameters (e.g., source, destination, priority) that may be contained in the metadata and collecting statistical information about the flows. Statistics collection may involve comparing the metadata against classifier rules that are configured by services/users and then retrieving existing statistics and updating them. The metadata collected/derived may depend on the fields the classifier supports (e.g., source IP address, destination IP address, protocol, source port, destination port) and the statistics that the system supports (e.g., packet size, ingress timestamp). Statistics collection may be memory and processor intensive. Accordingly, holding the packet in the network processor while the statistics collection is performed may likely affect the forwarding rate.

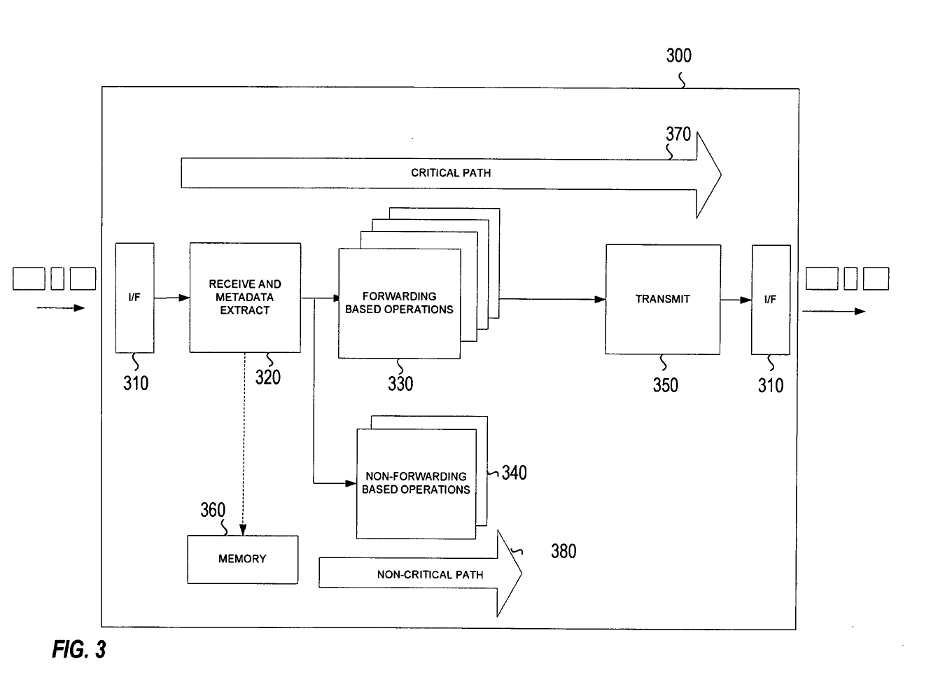

FIG. 3 illustrates an example network processor 300 having forwarding based operations and non-forwarding based operations parallel paths for processing of metadata associated with individual packets. The network processor 300 includes interfaces 310, a receiver 320, one or more forwarding based functional units 330, one or more non-forwarding based functional units 340, a transmitter 350, and memory 360 (e.g., cache). The interfaces 310 provide the connectivity for receiving and transmitting packets. The receiver 320 receives the packets and extracts/derives the metadata there from. The packets may be stored in the memory 360 or may be stored on external (off die) memory, such as DRAM (not illustrated). The packets are stored until they are ready for any necessary editing or transmission.

The forwarding based functional units 330 and the non-forwarding based functional units 340 form parallel paths. The operations of each parallel path can be performed independent of one another. The metadata collected/derived from a packet may be available to both the forwarding based functional units 330 and the non-forwarding based functional units 340. Alternatively, different metadata may be collected/derived for the forwarding based functional units 330 and the non-forwarding based functional units 340. The metadata may be stored in the memory 360. The metadata may be stored separately for each of the parallel paths. As the metadata may need to be accessed and possibly modified by multiple functional units 330, 340 the memory may be cache.

The tasks performed by the forwarding based functional units 330 include tasks that are required to be performed (e.g., editing, routing, scheduling) before the associated packets can egress the network processor 300. The operations are performed on the associated metadata in series. Once the forwarding based functional units 330 complete their operations, the associated packets may be forwarded to the transmitter 350 for transmitting (egressing) the packets from the network processor 300. The receiver 320, the forwarding based functional units 330, and the transmitter 350 may define the forwarding rate of the network processor 300 and thus be a critical path 370 in the network processor 300. One or more of the forwarding based functional units 330 may make changes to the metadata and may save the modified metadata in the cache 360 for use by other forwarding based functional units 330.

The tasks performed by the non-forwarding based functional units 340 include tasks that are not required to be performed prior to egressing the associated packets (they do not affect packet editing or packet forwarding decisions). The tasks performed by the non-forwarding based functional units 340 may include statistics collection. The results of the non-forwarding based functional units 340 may be provided to a core processor (not illustrated) for consolidation, analysis, and/or presentation to a user. The tasks performed by the non-forwarding based functional units 340 may make up a non-critical path 380 in the network processor 300. The non-forwarding based operations may be performed after the associated packets have been egressed from the network processor 300. One or more of the non-forwarding based functional units 340 may make changes to the metadata and may save the modified metadata in the cache 360 for use by other non-forwarding based functional units 340. The metadata associated with the non-forwarding operations of the associated packets may remain in the cache 360 until the operations of the non-forwarding functional units 340 are complete at which point the metadata may be discarded.

The forwarding based operations of the critical path 370 and the non-forwarding based operations of the non-critical path 380 are performed on parallel paths. The operations of the critical path 370 and the operations of the non-critical path 380 can be performed independent of the other. The non-forwarding based operations performed on the metadata for a particular packet do not interfere with the forwarding based operations performed on the metadata for the particular packet. The metadata associated with an individual packet may be the same for each parallel path or the metadata may be different for each path. Any changes made to the metadata on one path may have no impact on the metadata or operations of the other path. Performing non-forwarding operations on a parallel branch enables these tasks to be performed with minimal or no impact to the performance of the forwarding based operations (minimal or no impact on the forwarding rate).

Using cached metadata on a branched non-critical path 380 may assist in modular, incremental design of network processor applications. The branched path may utilize fewer resources, slower memory and slower processors so that more resources, faster memory, and faster processors can be dedicated to the critical path 370. The forwarding based operations making up the critical path 370 can be developed for the network processor 300 without regard to any operations not on the critical path 370 (e.g., the non-forwarding based operations). The non-forwarding based operations may be added as new features and services on parallel branches (e.g., non-critical paths 380) are required. The non-forwarding based parallel branches enable the non-forwarding operations to be added with minimal or no impact to the performance of the forwarding based operations. Thus, the need to re-architect the network processor 300 to add non-forwarding based functions may be reduced or eliminated.

The network processor 300 is illustrated as including a single non-critical path 380 formed in parallel to the critical path 370 but is not limited thereby. Rather any number of non-critical parallel paths 380 may be formed. Furthermore, the non-critical parallel paths 380 may branch off of the critical path 370 at any point. The configuration of the parallel non-critical branches depends on the operations being performed, how the processors are configured to implement the operations, and what operations are required to be performed prior to other operations.

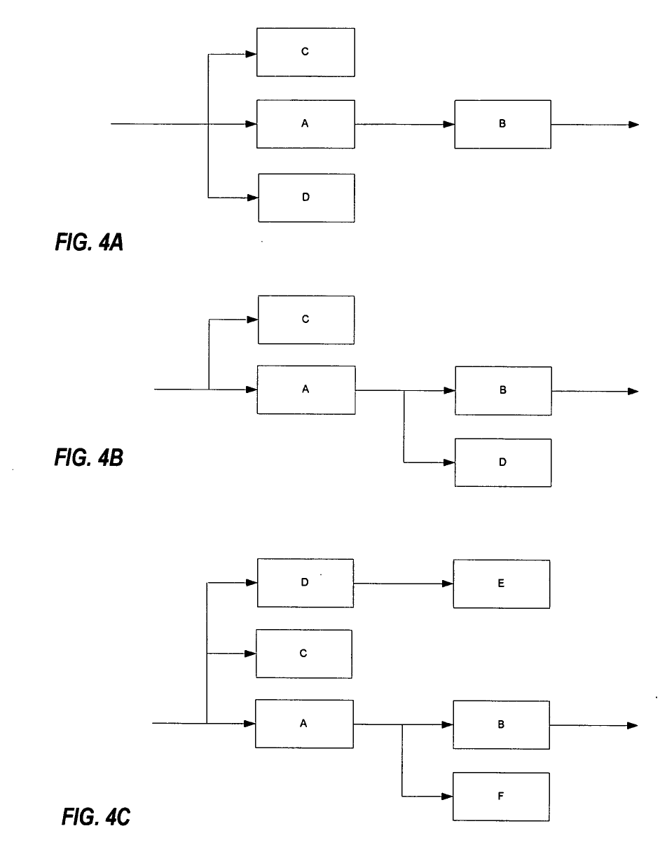

FIGS. 4A-4C illustrate several example critical path and non-critical parallel branches for processing of metadata associated with individual packets. Each of the FIGS. includes a critical path having functional units A and B performing forwarding based operations and one or more non-critical parallel branches having functional units performing non-forwarding based operations. FIG. 4A illustrates two non-critical paths each having a single functional unit (C and D respectively) branching off immediately prior to any function being performed on the critical path. The operation of the non-critical paths is not restricted by the operation of the critical path in any way.

FIG. 4B illustrates a first non-critical path having functional unit C branching off prior to operation of the functional unit A on the critical path. A second non-critical path includes functional unit D and branches off after the operation of functional unit A (may require functional unit A to perform its operations) but before functional unit B. FIG. 4C illustrates two non-critical paths branching off immediately prior to any function being performed on the critical path. A first non-critical path includes functional unit C and a second non-critical path includes functional units D and E. A third non-critical path includes functional unit F and branches off after the operation of functional unit A but before functional unit B.

The metadata used by the various parallel paths need not be the same. The metadata used by each parallel path may be different depending on the operations to be performed. Modifications to the metadata by any non-forwarding based functional unit on a non-critical path should not impact any forwarding based functional unit on the critical path or any other non-forwarding based functional unit on another non-critical path as the operations are parallel and independent. Modifications to the metadata by any functional unit on the critical path should not effect any parallel operations on another path. For example, modifications to the metadata by functional units A or B in FIG. 4A should not be used by functional units C and D on parallel branched paths as these operations are parallel. Modifications made to the metadata by functional unit A in FIGS. 4B and 4C may be utilized by the functional units D and F respectively as these operations are performed after the operations of functional unit A (parallel to functional unit B).

The functions performed on the metadata for an individual packet on the critical path are typically performed in series. However, the functions may not need to performed in an exact order. Accordingly, performing the functions in series may require one or more functions to wait for the completion of one or more other functions that they need not rely on. Having an operation wait for another operation that it need not rely on (follow) may impact the forwarding rate of the packets. Defining multiple parallel forwarding based paths of functions that need not rely on each other and can be performed separate from one another may help reduce packet processing time and hence reduce the impact to the forwarding rate.

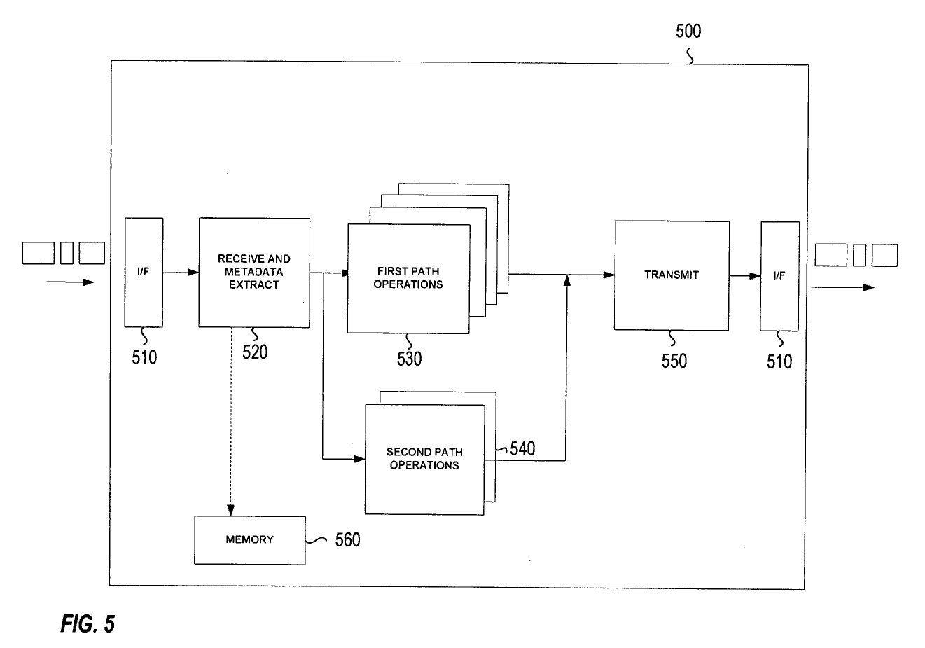

FIG. 5 illustrates an example network processor 500 defining parallel paths for processing of metadata associated with individual packets. The network processor 500 includes interfaces 510, a receiver 520, one or more first path functional units 530, one or more second path functional units 540, a transmitter 550, and memory 560 (e.g., cache). The interfaces 510 provide the connectivity for receiving and transmitting packets. The receiver 520 receives the packets and extracts the metadata. The metadata collected/derived from a packet may be the same for the first path functional units 530 and the second path functional units 540 or may be different based on operations to be performed. The metadata may be stored in the memory 560. The metadata may be stored separately for each of the parallel paths.

The first path functional units 530 and the second path functional units 540 access the metadata from the memory 560 as required. The operations performed by the first path functional units 530 and the second path functional units 540 may have limited or no dependence on one another (other than all forwarding based transactions need to be complete prior to the associated packets being egressed). Accordingly, both the first path and second path functional units 530, 540 may perform operations on the metadata associated with an individual packet in parallel (e.g., at the same time). Allowing multiple parallel branches to operate on the metadata associated with the same packets reduces packet processing latency.

It should be noted that the metadata may be modified by one of the functional units 530, 540 at some point and that the modified metadata may be stored in the memory 560 and be accessed by other functional units 530, 540. Each path may have its own metadata so that the metadata for one path does not effect the other path.

The network processor 500 is illustrated as including two parallel paths formed between the receiver 520 and the transmitter 550 but is not limited thereby. Rather any number of parallel paths may be formed and the parallel paths may be branched off and return (be formed) at any point. The configuration of the parallel branches depends on the operations being performed, how the functional units are configured to implement the operations, and what operations are required to be performed prior to other operations.

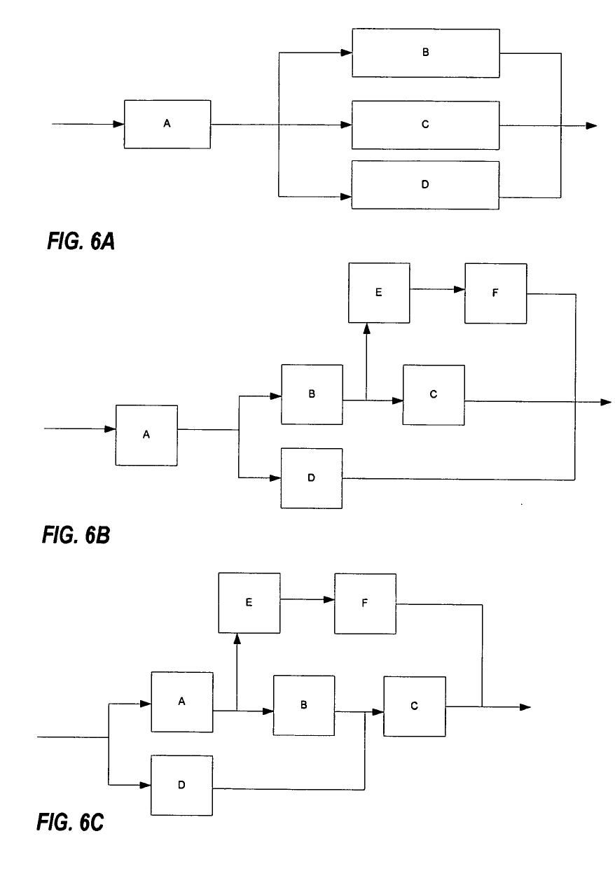

FIGS. 6A-6C illustrate several example parallel branches of functional units for performing parallel operations on metadata for individual packets. In each example, the parallel paths converge at some point (e.g., for egressing the packets). FIG. 6A illustrates a first configuration that includes a functional unit performing operation A and then splitting into three parallel paths each having a functional unit performing a specific operation (a first path performing operation B, a second performing operation C, and a third performing operation D). FIG. 6B illustrates a second configuration that includes a functional unit performing operation A and then splitting into two parallel paths. A first path includes two functional units performing operations B and C respectively, and a second path includes a functional unit performing operation D. After functional unit B on the first path, another parallel path branches off therefrom. The branched path includes two functional units performing operations E and F respectively.

FIG. 6C illustrates a third configuration in which two parallel paths are formed. A first path has three functional units performing operations A, B, C respectively. A second path has a functional unit performing operations D. The result from functional unit D is feed back to functional unit C. After functional unit A on the first path, a third parallel branch is formed. The third parallel branch includes two functional units performing operations E and F respectively.

A network processor may include multiple parallel critical paths as well as multiple parallel non-critical paths. Such a configuration would enable processing of forwarding based functions to be done in parallel so critical functions do not need to wait for functions that they are not dependent on while also allowing the non-critical functions to be performed but not impact the critical functions.

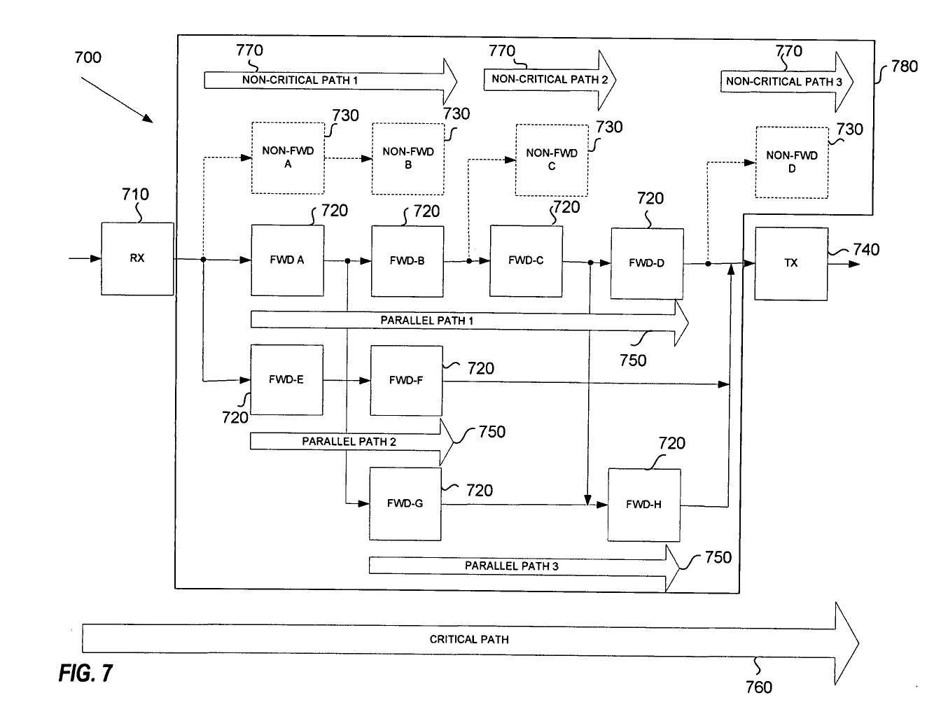

FIG. 7 illustrates an example network processor 700 defining multiple parallel critical paths and multiple parallel non-critical branches for processing of metadata associated with individual packets. The network processor 700 includes a receiver 710, a plurality of forwarding based functional units 720, a plurality of non-forwarding based functional units 730, and a transmitter 740. The forwarding based functional units 720 are arranged in three parallel paths 750. The arrangement of the parallel paths 750 make up the critical path 760. The non-forwarding based functional units 730 are arranged in non-critical (parallel) paths 770.

A first parallel path 750 includes forwarding based functional units A, B, C and D 720 in series. A second parallel path 750 includes forwarding based functional units E and F 720 in series. A third parallel path 750 includes forwarding based functional units G and H 720 in series, where functional unit G 720 awaits the operation of functional unit A 720 and functional unit H 720 awaits the operation of functional unit C 720 in addition to functional unit G 720.

A first non-critical path 770 includes non-forwarding functional units A and B 730 in series. A second non-critical path 770 includes non-forwarding functional unit C 730, where functional unit C 730 awaits the operation of forwarding functional unit B 720. A third non-critical path 770 includes non-forwarding functional unit D 730, where functional unit D 730 awaits the operation of forwarding functional unit D 720.

It should be noted that in FIGS. 3, 5 and 7, that a receiver received the packets and extracted/derived the metadata therefrom. The metadata extraction need not be part of the receiver. The metadata extraction may be a separate functional unit that extracts/derives the metadata after the receiver and before any other functional units. Alternatively, the metadata extraction/derivation may be part of a different functional unit than the receiver or may be distributed amongst several functional units.

FIGS. 3-7 illustrate parallel processing of metadata associated with the same packet. For example, an individual parallel packet processing block 780 includes the critical path 760 made up of forwarding processors 720 in parallel paths 750, and the parallel non-critical paths 770 made up of non-forwarding processors 730. The parallel processing of metadata associated with individual packets may be expanded so that multiple individual packets can each be processed in parallel. For example, the individual parallel packet processing block 780 may be replicated and the receiver 710 may route different packets to the individual parallel packet processing blocks 780.

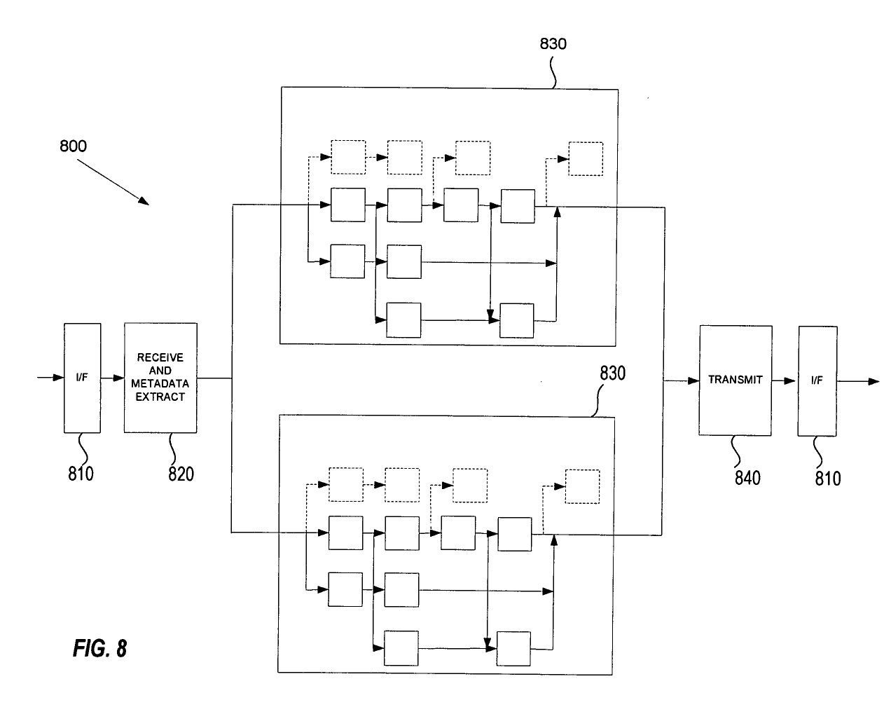

FIG. 8 illustrates an example network processor 800 having multiple parallel packet processing blocks (e.g., 780 of FIG. 7) where each block is capable or performing forwarding and non-forwarding based parallel operations on metadata associated with individual packets. The network processor 800 includes interfaces 810, a receiver 820, a plurality of parallel packet processing blocks 830, and a transmitter 840. The parallel packet processing blocks 830 may include parallel paths (illustrated as including both forwarding based and non-forwarding based parallel paths) for processing individual packets. The receiver 820 may route the packets between the plurality of parallel packet processing blocks 830 so that individual parallel packet processing of multiple packets can be performed in parallel.

FIG. 8 illustrates each parallel packet processing block 830 including its own non-critical path(s). However, the non-critical paths can be separated from the parallel packet processing blocks 830 and the non-critical path(s) can support each parallel packet processing block 830.

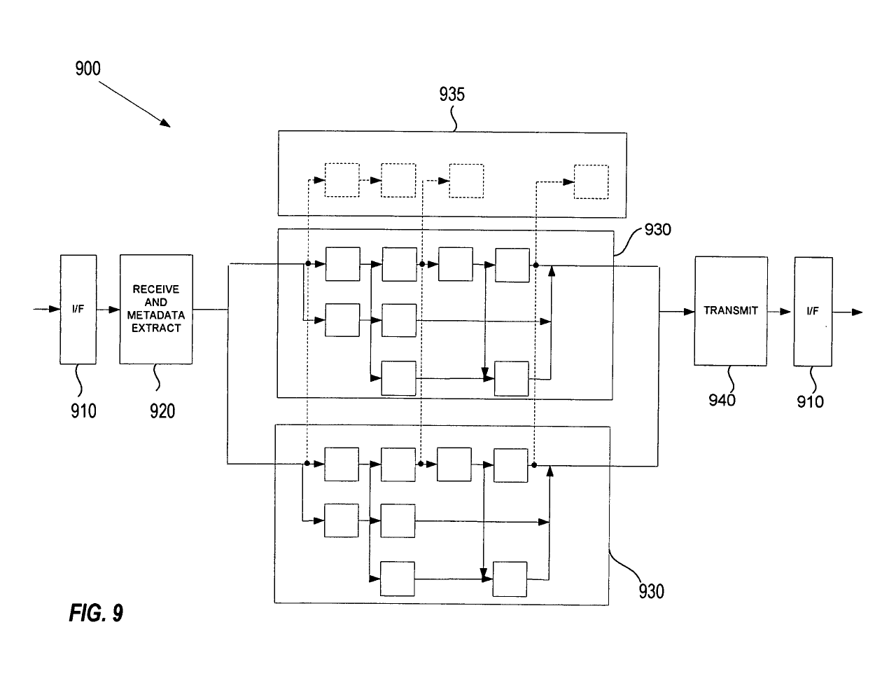

FIG. 9 illustrates an example network processor 900 having multiple forwarding based parallel packet processing blocks for performing forwarding based parallel operations on metadata associated with individual packets and a non-forwarding based parallel packet processing block for performing non-forwarding based parallel operations on metadata associated with each individual packet being processed by a forwarding based parallel packet processing block. The network processor 900 includes interfaces 910, a receiver 920, a plurality of forwarding based (critical) parallel packet processing blocks 930, a non-forwarding based parallel processing block 935 and a transmitter 940. The forwarding based parallel packet processing blocks 930 may include a single functional unit, multiple functional units in series, multiple functional units in parallel, or some combination thereof. As illustrated, the forwarding based parallel packet processing blocks 930 include multiple parallel paths of forwarding based functional units. The receiver 920 may route the packets between the plurality of forwarding based parallel packet processing blocks 930 so that processing of multiple packets can be performed in parallel. The non-forwarding based operations for each forwarding based parallel packet processing block 930 may be handled by the non-forwarding parallel processing block 935.

Although the various embodiments have been illustrated by reference to specific embodiments, it will be apparent that various changes and modifications may be made. Reference to “one embodiment” or “an embodiment” means that a particular feature, structure, or characteristic described in connection with the embodiment is included in at least one embodiment. Thus, the appearances of the phrase “in one embodiment” or “in an embodiment” appearing in various places throughout the specification are not necessarily all referring to the same embodiment.

Different implementations may feature different combinations of hardware, firmware, and/or software. In one example, machine-readable instructions can be provided to a machine (e.g., an ASIC, special function controller or processor, FPGA or other hardware device) from a form of machine-accessible medium. A machine-accessible medium may represent any mechanism that provides (i.e., stores and/or transmits) information in a form readable and/or accessible to the machine. For example, a machine-accessible medium may include: ROM; RAM; magnetic disk storage media; optical storage media; flash memory devices; electrical, optical, acoustical or other form of propagated signals (e.g., carrier waves, infrared signals, digital signals); and the like.

The various embodiments are intended to be protected broadly within the spirit and scope of the appended claims.

What is claimed:

1. A network processor comprising
one or more functional units performing forwarding based operations on metadata associated with a packet;
one or more functional units performing non-forwarding based operations on the metadata associated with the packet, wherein the non-forwarding based functional units are parallel to at least one of the forwarding based functional units; and
cache to store the metadata, wherein the metadata is maintained until the non-forwarding based operations are complete so the non-forwarding based operations can be completed after the associated packet is egressed.

2. The network processor of claim 1, further comprising
a receiver to receive the packet;
a functional unit to extract metadata from the packet; and
a transmitter to transmit the packet.

3. The network processor of claim 1, wherein the packet is egressed when the forwarding based operations on the metadata are complete.

4. The network processor of claim 1, wherein the forwarding based operations may include editing and forwarding decisions.

5. The network processor of claim 1, wherein the non-forwarding based operations may include statistics collection.

6. The network processor of claim 1, wherein the one or more forwarding based functional units form a critical path.

7. The network processor of claim 6, wherein the one or more non-forwarding based functional units form one or more non-critical parallel branches off the critical path.

8. The network processor of claim 1, wherein the one or more forwarding based functional units are arranged in a plurality of parallel forwarding based paths, and wherein the plurality of parallel forwarding based paths perform forwarding based operations on the metadata in parallel.

9. The network processor of claim 8, wherein the plurality of parallel forwarding based paths form a critical path.

10. The network processor of claim 1, wherein new non-forwarding based operations can be added in parallel to the forwarding based operations without impacting the forwarding based operations.

11. The network processor of claim 1, wherein the non-forwarding based functional units can utilize lower performance resources and the forwarding based functional units can utilize higher performance resources.

12. The network processor of claim 11, wherein the resources include memory and processing.

13. A machine-accessible medium comprising content, which, when executed by a machine causes the machine to:
extract metadata from a packet; and
cache the metadata, wherein the metadata is maintained until after the packet has been egressed so that non-forwarding based operations can be performed after the packet has been egressed.

14. The machine-accessible medium of claim 13, further causing the machine to
ingress the packet;
perform forwarding based operations on the metadata; and
egress the packet.

15. The machine-accessible medium of claim 14, wherein the packet is egressed when the forwarding based operations on the metadata are complete.

16. The machine-accessible medium of claim 14, further causing the machine to perform non-forwarding based operations on the metadata, wherein the non-forwarding based operations may be performed after the packet has been egressed.

17. The machine-accessible medium of claim 16, further causing the machine to discard the metadata after the non-forwarding based operations are complete.

18. A system comprising
a network processor including
a receiver to ingress packets;
a functional unit to extract metadata from the packets;
one or more functional units performing forwarding based operations on the metadata associated with an individual packet;
one or more functional units performing non-forwarding based operations on the metadata associated with the individual packet, wherein the non-forwarding based functional units are parallel to at least one of the forwarding based functional units;
cache to store the metadata associated with the individual packet, wherein the metadata is maintained until the non-forwarding based operations are complete so the non-forwarding based operations can be completed after the associated packet is egressed; and
a transmitter to egress the packets; and
dynamic random access memory to store the packets in queues responsive to said network processor.

19. The system of claim 18, wherein the transmitter egresses the individual packet when the forwarding based operations on the metadata are complete.

20. The system of claim 18, wherein the one or more forwarding based functional units form a critical path, and wherein the one or more non-forwarding based functional units form one or more non-critical parallel branches off the critical path.

21. The system of claim 18, wherein the one or more forwarding based functional units are arranged in a plurality of parallel forwarding based paths, and wherein the plurality of parallel forwarding based paths perform forwarding based operations on the metadata in parallel.

22. A network processor comprising
cache to store metadata associated with an individual packet;
two or more parallel paths of functional units performing operations on the metadata associated with the individual packet, wherein the two or more parallel paths can process the metadata for the individual packet in parallel.

23. The network processor of claim 22, wherein the cache stores metadata separate for each parallel path.

24. The network processor of claim 22, wherein changes made to the metadata for an individual packet on one parallel path are not required for operations on other parallel paths.

25. The network processor of claim 22, wherein the two or more parallel paths include functional units that perform at least some subset of forwarding and non-forwarding based operations on the metadata.
